(19) United States
(12) Patent Application Publication
(10) Pub. No.: US 2013/0335232 A1
(43) Pub. Date: Dec. 19, 2013

(54) Riser wireless communications system

(71) Applicants: Gareth Anthony John Conway, Armagh (GB); Mark Volanthen, Hampshire (GB); Brendan Hyland, Edinburgh (GB)

(72) Inventors: Gareth Anthony John Conway, Armagh (GB); Mark Volanthen, Hampshire (GB); Brendan Hyland, Edinburgh (GB)

(73) Assignee: WFS Technologies Ltd., Edinburgh (GB)

(21) Appl. No.: 13/821,910

(22) PCT Filed: Jun. 30, 2011
(86) PCT No.: PCT/GB11/00979

§ 371 Date: Aug. 30, 2013

(30) Foreign Application Priority Data
Jul. 2, 2010 (GB) 1011182.1

(51) Int. Cl. H04B 13/02

(52) U.S. Cl. CPC H04B 13/02
USPC 340/850

(57) ABSTRACT

The present invention discloses a wireless data command, control and instrumentation system for deployment within a subsurface hydrocarbon production system. Low frequency magnetic signalling is used to communicate from a first transceiver deployed inside a riser pipe to a second transceiver positioned outside the riser pipe. In some embodiments data is related to a control centre. Through pipe communications may be bi-directional.

### FIELD OF USE

The present invention relates to the field of underwater exploration, hydrocarbon extraction facilities and plants, general underwater installations and other underwater and deep-sea applications.

### DESCRIPTION OF THE RELATED ART

A typical hydrocarbon extraction facility comprises the following: a topside rig, which is located on the surface of the sea; a wellhead, where hydrocarbons are extracted from a well buried in the seabed; a production riser which connects from the wellhead on the seabed to the topside rig and which acts as a conduit for fluids between the rig and the wellhead; an umbilical which runs along the riser and which provides power and control of the well head from a control station in the topside rig. Similarly, a hydrocarbon drilling facility comprises a topside rig or drilling vessel; a wellhead installation, providing drilling access to a well buried in the seabed; a drilling riser which connects from the wellhead on the seabed to the topside rig and which acts as a conduit for fluids between the rig and the wellhead; an umbilical which runs along the riser and which provides power and control of the well head from a control station in the topside rig. Different risers are employed for drilling and production facilities, these are often referred to by the generic terms, marine riser or riser.

In shallow water applications, the topside well may be anchored to the seabed. In deep sea applications, the topside rig is typically positioned dynamically, i.e. without being anchored to the seabed and with the ability to move for alignment between the topside rig and the wellhead located on the seabed.

The riser connects to the wellhead via two segments: these are referred to as the Lower Marine Riser Package (LMRP) and the lower stack. Collectively, these two segments are known as a Blow-Out Preventer (BOP). The lower stack is fixed to the wellhead on the seabed and comprises valves, pressure sensors, actuators and other devices for maintaining and monitoring the state of the wellhead. The lower marine riser package is fixed to the lower end of the marine riser and comprises control and monitoring systems for controlling and monitoring the lower stack.

In normal operations, the marine riser remains connected to the wellhead via the blow-out preventer. An umbilical associated with the riser comprises electrical cables, and hydraulic lines which provide control of and monitor the state of the wellhead. Thus, control and monitoring of the wellhead is achieved via a direct wired link through an umbilical running beside the marine riser to the surface.

At the topside, lengths of pipe, typically referred to as a drill string, casing string or production string, as appropriate, is run through the riser and into the well. These tubing strings carry equipment such as the drill bit, casing, completion, intervention and logging tools to the desired positions in the well. Other tools, gauges and sensors can be run into the well on slickline and wireline also. We will use the term ‘string’ to refer to any means for conveying equipment into the well including tubing strings, wireline and slickline. The string passes through the riser, enters the blow-out preventer and wellhead before passing into the well.

Due to the great distances which can be involved in both water depth and well depth, it can be difficult to determine the exact location of the end of the string and thus the location of tools and devices mounted on the string. This is particular pertinent if the tools or string sticks in the well or in the event that the blow-out preventer may be operated. Thus it would be advantageous to be able to communicate between a device mounted on a string located in the riser to a device outside the riser.

WO2009/115798 describes a system and method for communicating electrical power and/or data signals along a production riser. The riser comprises an inner, electrically-insulating sheath defining a conduit and an outer, electrically-insulating layer surrounding the inner sheath so as to define an annulus in-between. The system comprises an electric current generator located at a predetermined position on the riser and operable to generate a current in the annulus; and a device positioned outside the outer layer of the pipe at a first location distant from the generator. The annulus is in electrical communication with the water at a second location on the riser distant from the generator such that an electrical return path extends through the water between the second location and the position of generator; and the device is operable to draw power and/or data from the current generated in the annulus by the generator. A method of communicating electrical power and/or data signals along a riser extending underwater comprises generating an electric current in the annulus at a predetermined position on the riser; positioning a device outside the outer layer of the pipe at a first location distant from the generator; providing an electrical return path extending through the water from a second location distant from the generator where the annulus is in electrical communication with the water to the position of generator; and operating the device to draw power and/or data from the current generated in the annulus by the generator.

While this describes a data communication system which operates along a riser, it does not offer the opportunity to communicate through the riser to a device located on a tubular string within the riser. It is further dependent on the riser being constructed in the fashion described and there being no interruptions in the layers over the distance of the riser between generators.

It is an object of the present invention to provide a system and method for communication data signals through a riser between a device on a string in the riser to a receiver outside the riser for onward transfer to the topside.

According to a first aspect of the present invention there is provided a communication system for data transfer between a first device located upon a string in a riser and a second device located outside the riser, the system comprising: a first transceiver mounted on the first device, the first device being located upon a string within a riser; a second transceiver mounted on the second device, the second device being located outside the riser; the first transceiver being arranged to transmit data in the form of electromagnetic signals and the second transceiver adapted to receive the electromagnetic signals when the first device and second device are substantially adjacent.

In this way, data is transferred through the riser. This removes the requirement to have communication links up the string. Additionally, if the location of the second device is known, the location of the first device is known when a signal is detected.

Preferably, the second device is mounted upon the outer surface of the riser. In this way, the position of the first device is known to be at the location of the second device when a signal is detected at the second device. Preferably also, there is a plurality of second devices located along a length of the riser. In this way, the progress of the first device and the string within the riser can be determined as a signal is detected in series along the second devices during passage of the string in the riser.

Alternatively, the second device is arranged to move along the outer surface of the riser. In this way, the second device may be mounted on an ROV and the location of the first device and position of the string can be determined at any position along the riser.

Preferably, the second transceiver is arranged to transmit electromagnetic signals and the first transceiver is arranged to receive electromagnetic signals. In this way, bi-directional communication is achieved.

Preferably, the first transceiver comprises an electric field coupled antenna. Preferably also the second transceiver comprises an electric field coupled antenna. In this way, the antenna can be located inside the device, embedded in the housing of the device or mounted in a plug located on the device and does not significantly increase the size of the device or interfere with the running of the string.

Alternatively, the transceiver may comprise a loop transducer. Optionally the transceiver may comprise a solenoid. In this way, any arrangement for transmitting and receiving electromagnetic signals may be used.

Preferably, the electromagnetic signal is modulated. In this way, data is transferred on the signal. More preferably, the signal has a carrier frequency less than or equal to 100 Hz. Such frequencies have been by the inventors to pass through the steel commonly used in construction of a riser, seawater and fluids flowing in the riser.

Preferably the second device includes means to communicate the data to the topside. Preferably the means is one of a group comprising: radio communications, acoustic signaling and a direct conductive wired link. In this way, known communication systems can be used between the second device and the topside.

The first device may include one or more sensors. In this way, measurements of physical parameters inside the riser can be transmitted to the topside. The first device may include actuators. In this way, the first device may be signaled to operate and carry out procedures either itself or via another device or tool while in the riser.

Preferably the second device is located adjacent the riser towards the wellhead. In this way, conditions in the wellhead can be monitored and/or operations can be carried out at the wellhead by transmission of signals between the devices.

In an embodiment a repeater is located at the riser. In this way, the second device can be located more remote from the riser. Such an arrangement would provide for communication through a buoyancy tank which may be mounted on the riser.

According to a second aspect of the present invention there is provided a method of communication from a device on a string in a riser to outside the riser, comprising the steps:
(a) Mounting a first transceiver on a device in a string;
(b) Running the string in a riser;
(c) Locating a second transceiver adjacent an outer surface of the riser; and
(d) Transmitting an electromagnetic signal between the transceivers.

Preferably, the method includes the step of relaying the transmitted signal to a topside.

Preferably, the method includes the step of moving the second transceiver along a length of the riser.

### BRIEF DESCRIPTION OF DRAWINGS

Embodiments of the present invention will now be described, by way of example only, with reference to the accompanying figures in which:

FIG. 1 shows a communication system according to a first embodiment of the present invention;

FIGS. 2(a) and (b3) show embodiments of a transducer for use in a communication system of the present invention;

FIG. 3 shows a further embodiment of a transducer for use in a communication system of the present invention;

FIG. 4 shows an example magnetic hysteresis characteristic;

FIG. 5 is a block diagram of a first device according to an embodiment of the present invention;

FIG. 6 is a block diagram of a first device according to an embodiment of the present invention;

FIG. 7 is a block diagram of a transceiver according to an embodiment of the present invention.

### DETAILED DESCRIPTION

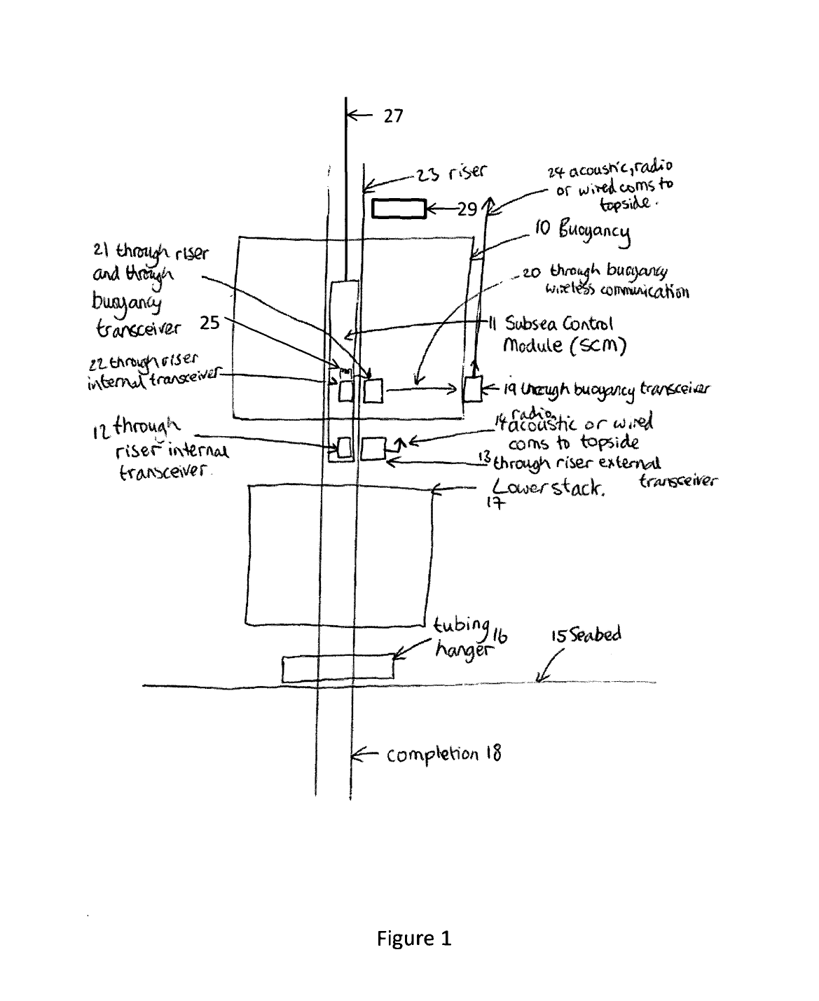

FIG. 1 shows a transceiver system deployed to communicate through a riser pipe to a transceiver deployed outside of the riser pipe in one embodiment of the present invention. Riser pipe 23 runs from a production platform through the sea to the seabed 15 and penetrates the seabed at completion 18. Subsea Control Module 11 requires relay of data from integrated sensors to a transceiver outside of the pipe structure and communication of control commands from outside the pipe structure. Transceiver 22 communicates through the pipe wall with transceiver 21 which is embedded inside buoyancy tank 10. Transceiver 21 then relays communications signals to a further transceiver 19 which is external to the buoyancy tank. Transceiver 19 is in communications with a control centre via communications link 24 which is implemented using radio communications, acoustic signalling or a direct conductive wired link. In sections of the riser which are not enclosed by buoyancy tank 10 transceiver 12 communicates with transceiver 13 which is positioned outside the riser pipe. Transceiver 13 is in communications with a control centre via communications link 14 which is implemented using radio communications, acoustic signalling or a direct conductive wired link. Buoyancy 10 is typically located above lower stack 17 and tubing hanger 16. Buoyancy tank 10 is typically filled with a low density material to ensure water is excluded from the buoyancy tank and this material provides a much lower attenuation of electromagnetic signals than steel components or the surrounding sea water.

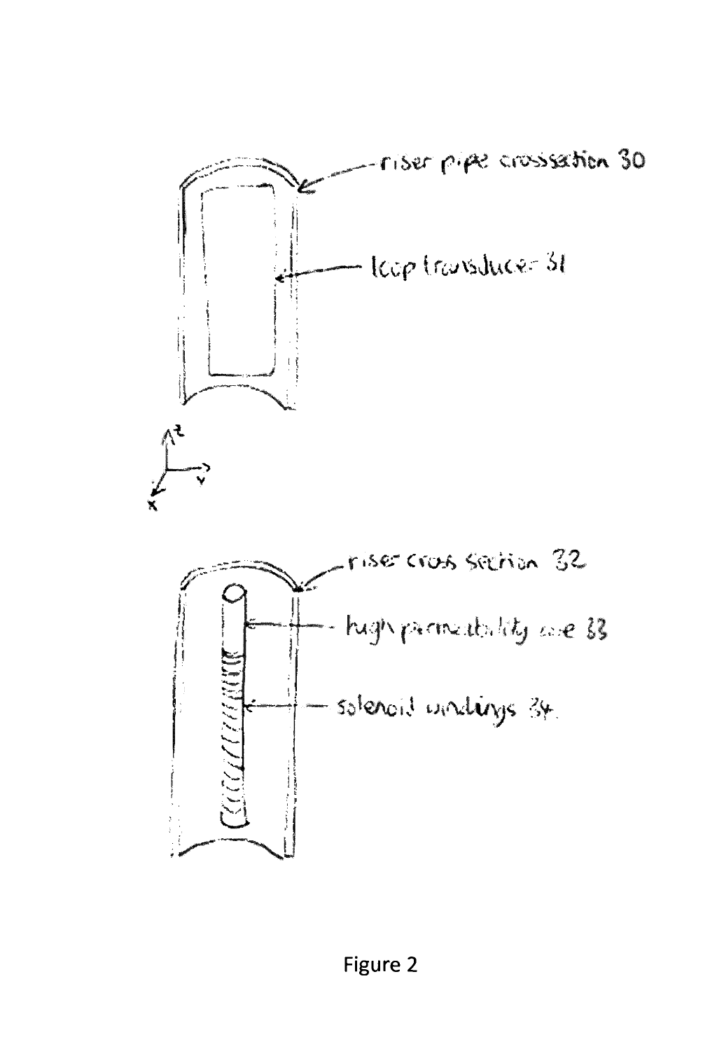

FIG. 2 shows transducers deployed inside a pipe structure for generating or receiving an electromagnetic field. Riser pipe 30 is shown in cross section to reveal enclosed loop transducer 31. Loop 31 is arranged with its plane in the Y-Z plane as this maximises enclosed area within the confined space of the riser pipe. Enclosed area is one of the parameters that improves the performance of a loop electromagnetic transducer. Transmit performance of a loop or solenoid transducer is related to the magnetic moment which is the product of current and area and is multiplied by the effective permeability of the core material. For a receive transducer the magnitude of an induced signal in a magnetic core antenna is given by the following equation.

emf=nAωμ_{ε}μ₀H₀ Equation 1

where
μ_{E}=effective magnetic permeability of core,
μ₀=magnetic permeability of free space (4π×10⁻⁷ Am⁻¹),
ω=angular frequency,
n=number of windings of solenoid,
A=Cross sectional area of magnetic core,
H₀=Magnetic field strength of incident electromagnetic signal in the absence of the core.

A given input signal has a given angular frequency w and produces a given magnetic field strength H₀ at the antenna. The sensitivity of the antenna is determined by the variables independent of the input signal in equation 1; i.e. the number of windings of the coil, n, the area of the magnetic core, A, the effective permeability μ_{E} of the core.

Loop area can be increased by using the relatively unconstrained Z dimension to extend a loop antenna deployed within a pipe. This orientation also has the benefit of producing field lines that are orthogonal to the circumference of the pipe. For loops deployed in the X-Y plane the circular conductive pipe acts as a shorted turn and in this orientation current is induced in the pipe which acts to reduce the field generated by the loop to the detriment of the communications link budget.

In a further embodiment a solenoid may be employed as the transducer internal to the pipe. In FIG. 2 riser cross section 32 reveals a solenoid deployed with its main axis in a Z orientation along the length of the pipe. Solenoid windings 34 are wrapped around high permeability core 33. For a solenoid, effective permeability is typically much lower than the bulk intrinsic permeability of the core material. Effective permeability is highest for a rod with a high length to cross sectional area ratio. So deployment as shown in FIG. 2 allows a longer solenoid length which improves transmit and receive performance.

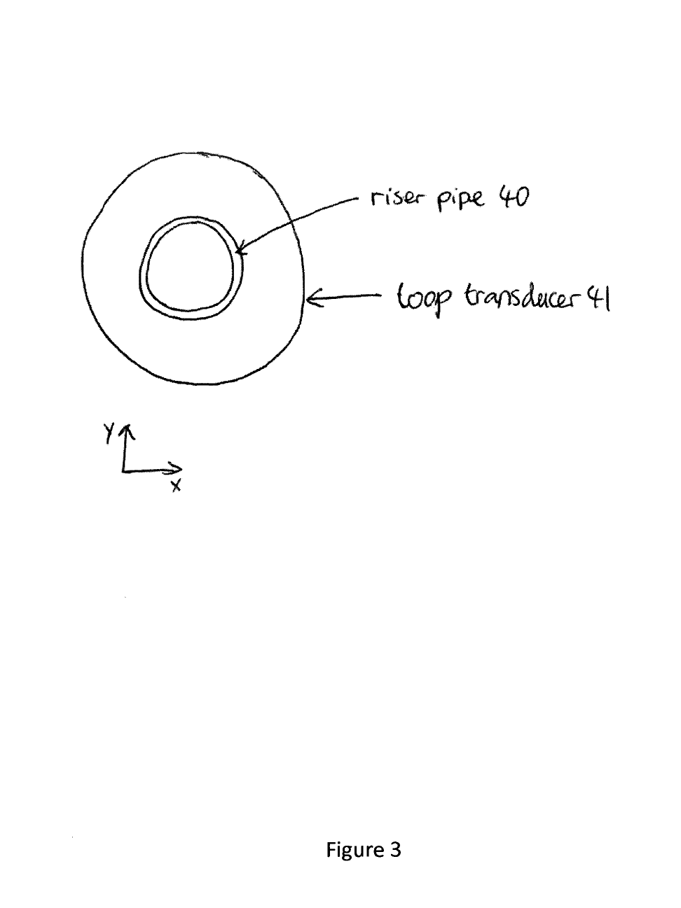

FIG. 3 shows a loop transducer deployed around a pipe structure for generating or receiving an electromagnetic field. FIG. 3 shows a cross section through the riser pipe 40 in the X-Y plane. Loop transducer 41 is deployed around the riser pipe. This geometry allows an unconstrained cross sectional area which improves transducer performance. This loop can be deployed within the buoyancy tank where an increase in loop enclosed area will not enclose any additional conductive material as it would if deployed in the sea water surrounding the riser.

Electromagnetic signals are highly attenuated when passing through an electrically conductive material. Steel typically has relative permeability in region of 100-8000 depending on applied field strength and steel grade. Steel pipe conductivity is approx 3.8-4.8×10⁶ Sm⁻¹ while the surrounding sea water typically has a conductivity of 2 to 4 Sm⁻¹. Electromagnetic attenuation increases rapidly with frequency and this drives us toward the use of low carrier frequencies in a through steel communications system to achieve the required operational range. For example, in some embodiments a carrier signal of 100 Hz may be used. A modulated electromagnetic signal occupies a spectral bandwidth which is dependent on bit rate and the modulation scheme used. High order modulation schemes, for example 64 QAM, reduce the required bandwidth and this is beneficial for enabling the required link capacity in a low frequency signalling system.

The transmission channel through steel, and to a lesser extent through sea water, is highly dispersive in phase and gain due to the material's high conductivity. Phase and amplitude equalisation schemes may be employed to allow operation of high order modulation schemes.

The electromagnetic signalling path in this system may include many layers of varying material including riser casing; riser steel pipe; riser buoyancy material; riser fluids e.g. ZnBr, CaBr, CaCI; surface rust; pipe scale; sea water. For example, the riser may be of steel at X65 or X80 steel with an inner diameter of 19 inches and an outer diameter of 21 inches.

Where a through sea water radio communications link is used for onward transmission to the surface a relay system using several transceivers on the riser may be required to achieve the required range at the required data rate.

The communications data rate requirement in a hydrocarbon production system is typically asymmetric. Command and control from the topside to equipment within the production system requires a lower bandwidth, for example 10 bps, than the recovery of data from embedded equipment to the control centre which for example may take place at 10 kbps or higher.

The communications system is typically lowered temporarily into the riser pipe as part of a landing string system to perform work inside the well.

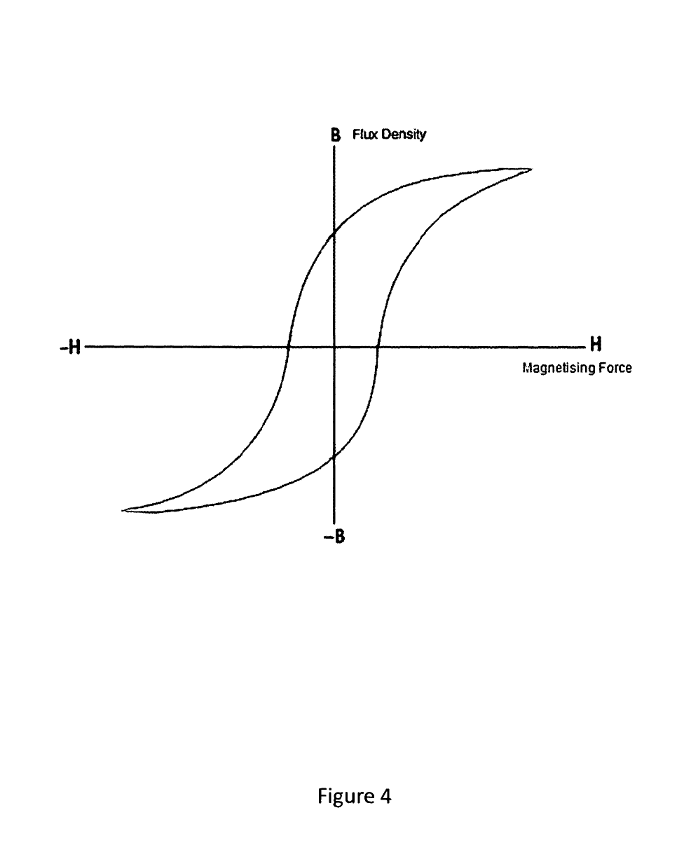

FIG. 4 shows an example of the well known magnetic hysteresis characteristic for a ferrous material. It shows how flux density B responds to application and reduction of magnetising force H. It shows that as the applied magnetic field increases in magnitude the corresponding flux density response starts to saturate eventually reaching a maximum value. Magnetic saturation of the steel structures within the riser and supporting equipment will limit the maximum useful signal that may be used to overcome the considerable losses encountered when using electromagnetic signalling to communicate through the steel riser structure. The non-linear response also distorts the signal and is another reason magnitude and phase equalisation schemes will be required in the present system. Magnitude and phase equalisation schemes are well known within the field of radio communications and these general schemes will be applicable to this application and not repeated here.

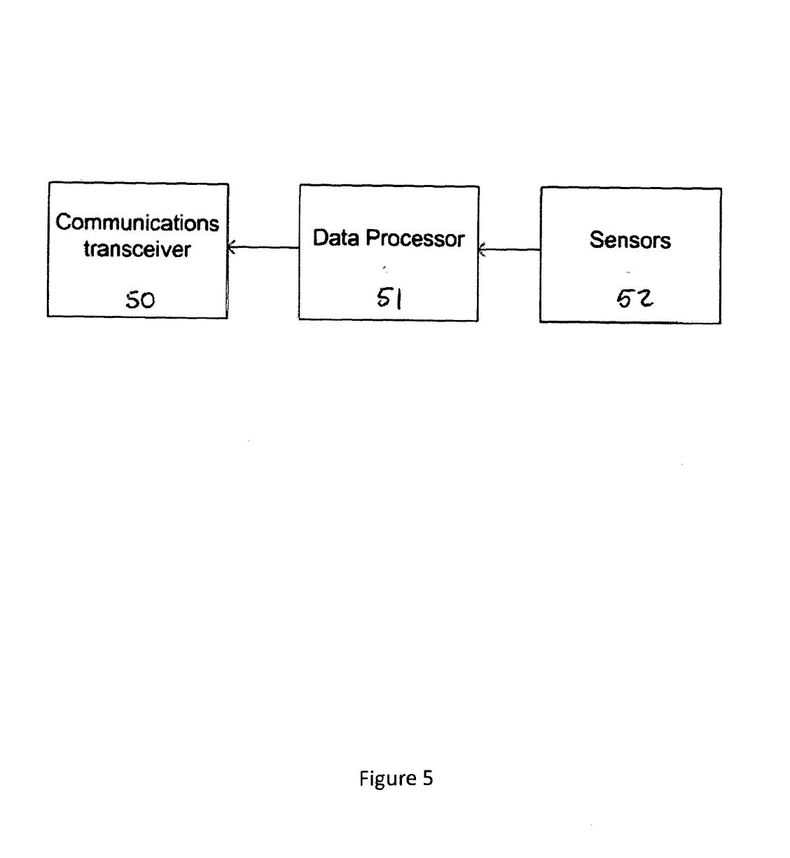

FIG. 5 shows how the transceiver of the present invention may be configured to communicate data from a sensor. Sensor 52 monitors a parameter of interest which may include pressure, temperature, valve position, flow rate and generates data which is passed to data processor 51 where it is processed to generate a form which can be interfaced with communications transceiver 50.

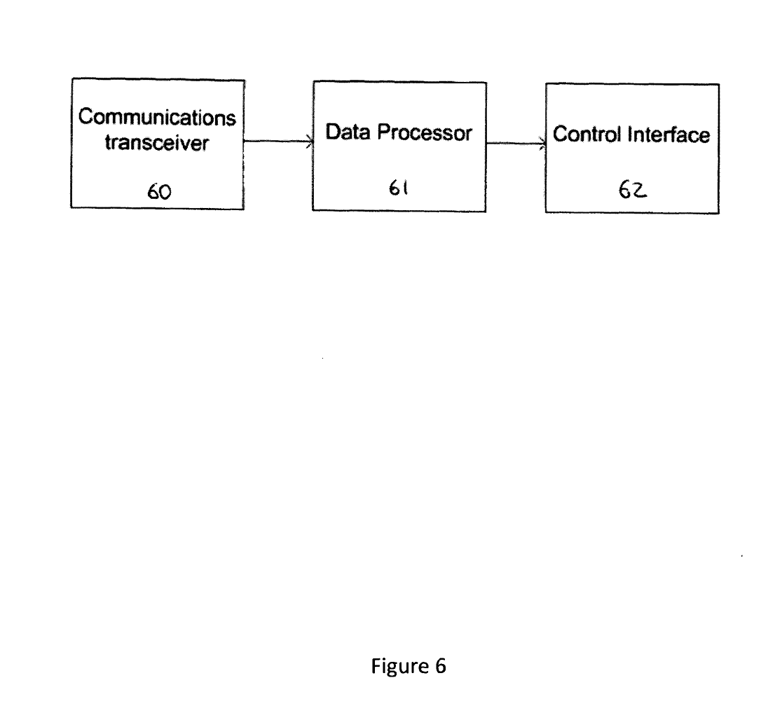

FIG. 6 shows how the transceiver of the present invention may be configured to communicate data to a control interface. Communications transceiver 60 receives a modulated signal and processes the signal to generate a data stream which is forwarded to data processor 61. This data is then presented at control interface 62 which acts to control equipment deployed within the production system.

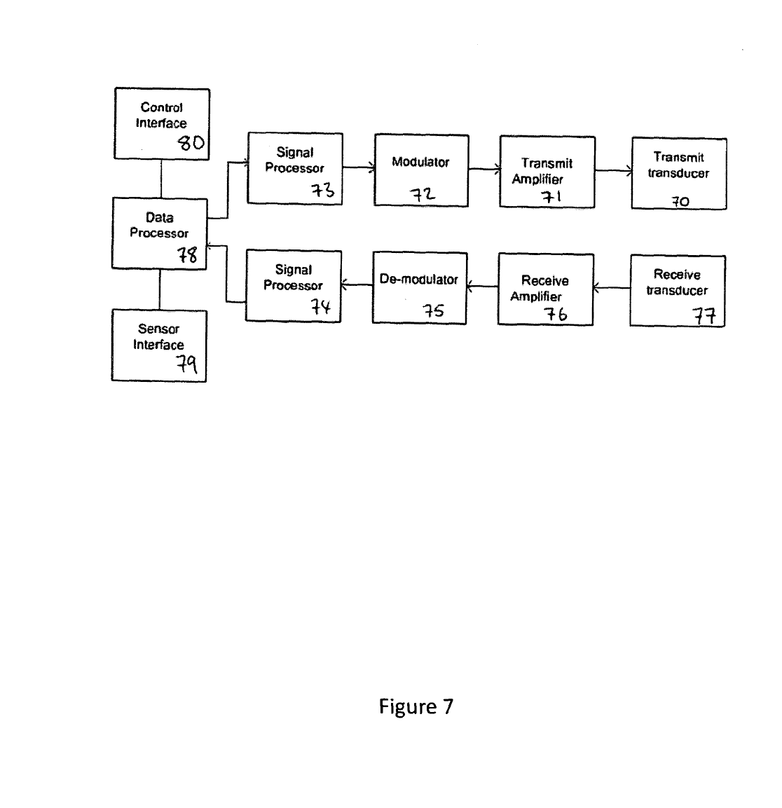

FIG. 7 is a block diagram of a transceiver of the present invention. Receive transducer 77 receives a modulated signal which is amplified by receive amplifier 76. De-modulator 75 mixes the received signal to base band and detects symbol transitions. The signal is then passed to signal processor 74 which processes the received signal to extract data. Data is then passed to data processor 78 which in turn forwards the data to control interface 80. Sensor interface 79 receives data from deployed sensors which is forwarded to data processor 78. Data is then passed to signal processor 73 which generates a modulated signal which is modulated onto a carrier signal by modulator 72. Transmit amplifier 71 then generates the desired signal amplitude required by transmit transducer 70.

In use, a device such as the subsea control module 11, is run into the riser 23 on a string 27. Progress of the descent of the module 11 can be monitored by the transceivers 14 mounted on the riser. Where transceivers 14 are arranged along a length of the riser 23, electromagnetic signals transmitted from the antenna 25 will come into range of each transceiver 14 in series down the riser 23. When the module 11 the lowermost transceiver 14, determined by reception of a signal from this transceiver 14, the string can be stopped so that the module is located at a desired position. In the embodiment shown in FIG. 1, this is at the wellhead. At this position, the transceiver 12 can now transmit data from sensors or other gauges housed within the module to provide information on the environment within the lower stack 17, housing the BOP and the wellhead. Additionally, transceiver 14 can transmit control signals to the transceiver 12 to control operations in the module 11. This could be to actuate tools in the module 11. If the module 11 requires to be located at the buoyancy tank 10, signals are transmitted via the repeater 21.

An alternative use may be having transceiver 12 located on string 27 and run in the riser 23 as before, but in this embodiment, the string 27 becomes stuck in the well. This can occur when the string 27 is a drill string or where the string 27 carries logging or intervention tools. With the string in a fixed position, the transceiver 12 can transmit electromagnetic signals which can be detected outside the riser 23. If fixed transceivers 14 are located on the riser 23, one of these may pick-up the signal and thus provide a position of the transceiver 12 and thus the location of tools on the string 27 in the riser 23. An alternative embodiment is to mount the transceiver 14 on an ROV (remotely operable vehicle) 29. The ROV 29 is then moved along the outside of the riser 23 through the seawater. When flown along the length of the riser 23, transceiver 14 will receive the signal from the transceiver 12 within the riser 23, when the ROV 29 is at the position on the riser 23 where the transceiver 12 is located within the riser 23. Once the position is identified, data and control can be communicated between the ROV 29 and the string 27, which can assist in determining the reason for the problem or actuate tools to release at least a portion of the string 27. By determining the location of the string in the riser 23, a precise location of what portion of the string 27 is at the rams of the BOP can be given. This information can be used to make a decision on whether operating the BOP to splice the string 27 would be useful to recovery.

The descriptions of the specific embodiments herein are made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

1. A communication system for data transfer between a first device located upon a string in a riser and a second device located outside the riser, the system comprising: a first transceiver mounted on the first device, the first device being located upon a string within a riser; a second transceiver mounted on the second device, the second device being located outside the riser; the first transceiver being arranged to transmit data in the form of electromagnetic signals and the second transceiver adapted to receive the electromagnetic signals when the first device and second device are substantially adjacent.

2. A communication system according to claim 1 wherein the second device is mounted upon the outer surface of the riser.

3. A communication system according to claim 2 wherein there is a plurality of second devices located along a length of the riser.

4. A communication system according to claim 1 wherein the second device is arranged to move along the outer surface of the riser.

5. A communication system according to claim 1 wherein the second transceiver is arranged to transmit electromagnetic signals and the first transceiver is arranged to receive electromagnetic signals.

6. A communication system according to claim 1 wherein the first transceiver comprises an electric field coupled antenna.

7. A communication system according to claim 6 wherein the second transceiver comprises an electric field coupled antenna.

8. A communication system according to claim 1 wherein the transceiver includes a loop transducer.

9. A communication system according to claim 1 wherein the transceiver includes a solenoid.

10. A communication system according to claim 1 wherein the electromagnetic signal is modulated.

11. A communication system according to claim 1 wherein the signal has a carrier frequency less than or equal to 100 Hz.

12. A communication system according to claim 1 wherein the second device includes means to communicate the data to the topside.

13. A communication system according to claim 12 wherein the means to communicate the data is by one of a group comprising: radio communications, acoustic signaling and a direct conductive wired link.

14. A communication system according to claim 1 wherein the first device include one or more sensors.

15. A communication system according to claim 1 wherein the first device includes actuators.

16. A communication system according to claim 1 wherein the second device is located adjacent the riser towards the wellhead.

17. A communication system according to claim 1 wherein a repeater is located at the riser.

18. A method of communication from a device on a string in a riser to outside the riser, comprising the steps:
(a) mounting a first transceiver on a device in a string;
(b) running the string in a riser;
(c) locating a second transceiver adjacent an outer surface of the riser; and
(d) transmitting an electromagnetic signal between the transceivers.

19. A method of communication according to claim 18 wherein the method includes the step of relaying the transmitted signal to a topside.

20. A method of communication according to claim 18 wherein the method includes the step of moving the second transceiver along a length of the riser.
